(19) United States
(12) Patent Application Publication
(10) Pub. No.: US 2009/0237339 A1
(43) Pub. Date: Sep. 24, 2009

(54) LIQUID CRYSTAL DISPLAY DEVICE BASED ON DOT INVERSION OPERATION

(76) Inventors: Cheng-Chiu Pai, Hsin-Chu (TW); Chung-Chun Chen, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/102,870

(22) Filed: Apr. 15, 2008

(30) Foreign Application Priority Data
Mar. 18, 2008 (TW) 097109463

(51) Int. Cl. G09G 3/36

(52) U.S. Cl. 345/90; 345/92

(57) ABSTRACT

An LCD device based on dot inversion operation is disclosed. The LCD device includes a plurality of data lines, a plurality of gate lines, a plurality of common lines, and a plurality of pixel units. Each pixel unit includes a data switch and a storage capacitor. The data switch of each pixel unit is coupled to a corresponding data line, a corresponding gate line, and the storage capacitor of same pixel unit. The storage capacitor of each pixel unit is also coupled to the storage capacitor of a corresponding pixel unit disposed diagonal to the pixel unit via a corresponding common line. The LCD device is capable of writing a plurality of low-voltage data signals having different polarities based on different common voltages into the plurality of pixel units so that the dot inversion operation can be operated with lower gray-scale voltage swing.

### BACKGROUND OF THE INVENTION

1. Field of the Invention

The present invention relates to a liquid crystal display device, and more particularly, to a liquid crystal display device based on low-voltage dot inversion operation.

2. Description of the Prior Art

Because liquid crystal display (LCD) devices are characterized by thin appearance, low power consumption, and low radiation, LCD devices have been widely applied in various electronic products such as computer monitors, mobile phones, personal digital assistants (PDAs), or flat panel televisions. In general, the LCD device comprises liquid crystal layers encapsulated by two substrates and a backlight system for providing lighting source. The operation of an LCD apparatus is featured by varying voltage drops between opposite sides of the liquid crystal layers for twisting the angles of the liquid crystal molecules of the liquid crystal layers so that the transparency of the liquid crystal layers can be controlled for illustrating images with the aid of the backlight system.

It is well known that the polarity of voltage drop across opposite sides of the liquid crystal layer should be inverted periodically for protecting the liquid crystal layer from causing permanent deterioration due to polarization, and also for reducing image sticking effect on the LCD device. In general, the driving methods used for LCD devices comprise the frame-inversion driving method, the line-inversion driving method, the pixel-inversion driving method, and the dot-inversion driving method.

While driving an LCD device based on the frame-inversion driving method, the polarities of data applied to each liquid crystal cell are inverted with respect to alternating display frames. The line-inversion driving method includes the column-inversion driving method and the row-inversion driving method. While driving an LCD device based on the column-inversion driving method, the polarities of data applied to each liquid crystal cell are inverted with respect to alternating data lines. While driving an LCD device based on the row-inversion driving method, the polarities of data applied to each liquid crystal cell are inverted with respect to alternating gate lines. While driving an LCD device based on the pixel-inversion driving method, data signals having opposite polarities are applied to adjacent pixels, and the data signals of the red, green, and blue pixel units in the same pixel have the same polarity. While driving an LCD device based on the dot-inversion driving method, data signals having opposite polarities are applied to adjacent pixel units.

Among the aforementioned LCD panel driving methods, the dot-inversion driving method allows a certain liquid crystal cell to have a data signal having a polarity contrary to data signals applied to its adjacent liquid crystal cells in the vertical and horizontal directions, and thereby provides a picture having a better display quality than the other driving methods. In light of this advantage, recently LCD panels have mainly used the dot-inversion driving method for displaying images.

Please refer to FIG. 1 and FIG. 2. FIG. 1 is a schematic diagram showing the polarities of data written into the Nth frame 100 in the dot-inversion operation of a liquid crystal display device. FIG. 2 is a schematic diagram showing the polarities of data written into the (N+1)th frame 200 next to the Nth frame 100. Signs “+” (when the pixel voltage minus the common voltage is positive) and “−” (when the pixel voltage minus the common voltage is negative) in FIGS. 1 and 2 indicate the polarities of data written into each pixel unit. As shown in FIGS. 1 and 2, data signals of adjacent pixel units have opposite polarities in both the Nth and (N+1)th frames. Furthermore, the data signals corresponding to the same pixel unit in the Nth frame and the (N+1)th frame also have opposite polarities. That is, the data signal of each pixel unit inverts polarity while alternating display frames.

Please refer to FIG. 3, which is a schematic diagram illustrating the gray-scale voltages used in a prior-art liquid crystal display device. In general, DC common voltage Vcom is applied to the prior-art liquid crystal display device for performing dot-inversion operation. Consequently, the voltage swings between the gray-scale voltages VGP0-VGP63 having positive-polarity and the gray-scale voltages VGN0-VGN63 having negative-polarity are falling to a wide voltage range, which results in higher power consumption while switching polarities of the gray-scale voltages. In addition, the components installed in the driving circuits of the prior-art liquid crystal display device should be compatible with the extensive voltage swing operation. That is, the components of the driving circuits should be fabricated based on a costly High-Voltage IC fabrication process.

### SUMMARY OF THE INVENTION

In accordance with an embodiment of the present invention, a liquid crystal display device based on dot inversion operation is disclosed. The liquid crystal display device comprises a plurality of parallel data lines, a plurality of parallel gate lines, a plurality of parallel storage capacitor common lines, an Nth row of pixel units, and an (N+1)th row of pixel units.

Each of the data lines is utilized to receive a corresponding data signal. The plurality of parallel gate lines are crossed with the plurality of data lines perpendicularly. Each of the gate lines is utilized to receive a corresponding gate signal. The plurality of parallel storage capacitor common lines are crossed with the plurality of data lines perpendicularly. Each of the storage capacitor common lines is utilized to receive a corresponding storage capacitor common voltage. The Nth row of pixel units comprises an Mth pixel unit and an (M+1)th pixel unit. The Mth pixel unit of the Nth row of pixel units comprises a first data switch and a first storage capacitor. The first data switch comprises a first end coupled to the first storage capacitor, a second end coupled to an (M+1)th data line of the data lines, and a gate coupled to an Nth gate line of the gate lines. The (M+1)th pixel unit of the Nth row of pixel units comprises a second data switch and a second storage capacitor. The second data switch comprises a first end coupled to the second storage capacitor, a second end coupled to an (M+2)th data line of the data lines, and a gate coupled to the Nth gate line. The (N+1)th row of pixel units comprises an Mth pixel unit and an (M+1)th pixel unit. The Mth pixel unit of the (N+1)th row of pixel units comprises a third data switch and a third storage capacitor. The third data switch comprises a first end coupled to the third storage capacitor, a second end coupled to an Mth data line of the data lines, and a gate coupled to an (N+1)th gate line of the gate lines. The (M+1)th pixel unit of (N+1)th row of pixel units comprises a fourth data switch and a fourth storage capacitor. The fourth data switch comprises a first end coupled to the fourth storage capacitor, a second end coupled to the (M+1)th data line, and a gate coupled to the (N+1)th gate line.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing the polarities of data written into the Nth frame in the dot-inversion operation of a liquid crystal display device.

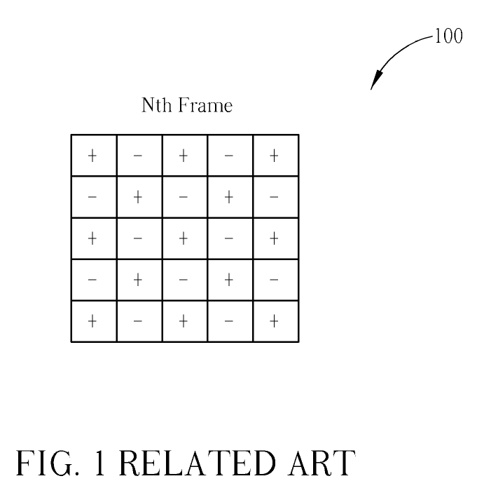

FIG. 2 is a schematic diagram showing the polarities of data written into the (N+1)th frame next to the Nth frame.

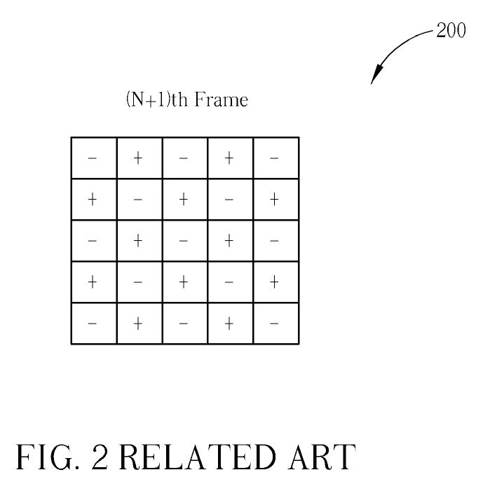

FIG. 3 is a schematic diagram illustrating the gray-scale voltages used in a prior-art liquid crystal display device.

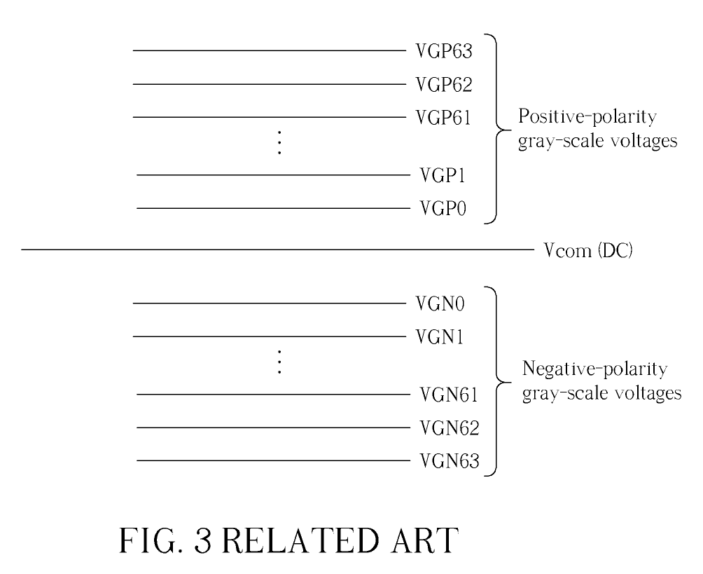

FIG. 4 is a structural diagram schematically showing a liquid crystal display device based on dot-inversion operation in accordance with a first embodiment of the present invention.

FIG. 5 is a diagram schematically showing the pixel voltage polarities of the Ith frame having dot-inversion feature generated based on the liquid crystal display device shown in FIG. 4.

FIG. 6 shows the related signal waveforms for generating the Ith frame based on the liquid crystal display device shown in FIG. 1, having time along the abscissa.

FIG. 7 is a diagram schematically showing the pixel voltage polarities of the (I+1)th frame having dot-inversion feature generated based on the liquid crystal display device shown in FIG. 4.

FIG. 8 shows the related signal waveforms for generating the (I+1)th frame based on the liquid crystal display device shown in FIG. 1, having time along the abscissa.

FIG. 9 is a structural diagram schematically showing a liquid crystal display device based on dot-inversion operation in accordance with a second embodiment of the present invention.

### DETAILED DESCRIPTION

Hereinafter, preferred embodiments of the present invention will be described in detail with reference to the accompanying drawings. Here, it is to be noted that the present invention is not limited thereto.

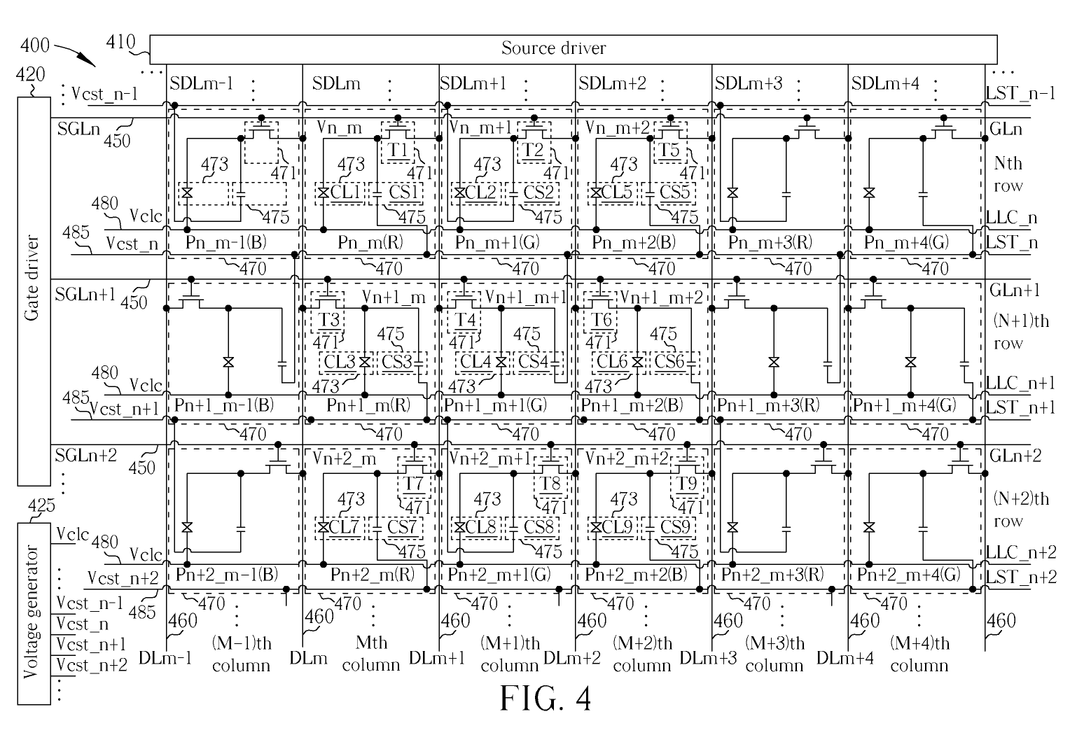

FIG. 4 is a structural diagram schematically showing a liquid crystal display device based on dot-inversion operation in accordance with a first embodiment of the present invention. As shown in FIG. 4, the liquid crystal display device 400 comprises a source driver 410, a gate driver 420, a voltage generator 425, a plurality of parallel data lines 460, a plurality of parallel gate lines 450, a plurality of parallel liquid-crystal capacitor common lines 480, a plurality of storage capacitor common lines 485, and a plurality of pixel units 470. For the sake of brevity, FIG. 4 demonstrates only six data lines DL_m−1-DL_m+4, three liquid-crystal capacitor common lines LLC_n-LLC_n+2, three gate lines GL_n-GL_n+2, four storage capacitor common lines LST_n−1-LST_n+2, and several pixel units Pn_m−1-Pn+2_m+4.

The source driver 410 is utilized to provide a plurality of data signals. The gate driver 420 is utilized to provide a plurality of gate signals. The voltage generator 425 is utilized to provide a liquid-crystal capacitor common voltage Vclc and a plurality of storage capacitor common voltages. Each data line 460 is coupled to the source driver 410 for receiving a corresponding data signal. For instance, the data line DLm is utilized to receive a data signal SDLm, and the data line DLm+3 is utilized to receive a data signal SDLm+3.

The pluralities of gate lines 450, liquid-crystal capacitor common lines 480, and storage capacitor common lines 485 are crossed with the plurality of data lines 460 perpendicularly. Each gate line 450 is coupled to the gate driver 420 for receiving a corresponding gate signal. For instance, the gate line GLn is utilized to receive a gate signal SGLn, and the gate line GLn+1 is utilized to receive a gate signal SGLn+1. Each liquid-crystal capacitor common line 480 is coupled to the voltage generator 425 for receiving the liquid-crystal capacitor common voltage Vclc. Each storage capacitor common line 485 is coupled to the voltage generator 425 for receiving a corresponding storage capacitor common voltage. For instance, the storage capacitor common line LST_n is utilized to receive a storage capacitor common voltage Vcst_n, and the storage capacitor common line LST_n+1 is utilized to receive a storage capacitor common voltage Vcst_n+1. Each pixel unit 470 comprises a corresponding data switch 471, a corresponding liquid crystal capacitor 473, and a corresponding storage capacitor 475.

In the embodiment shown in FIG. 4, the R, G, or B labeled in parentheses at each pixel unit 470 is utilized to signify a red, green, or blue pixel unit. Consequently, the pixel units 470 disposed in the same column have same pixel color in the liquid crystal display device 400. For instance, the pixel units 470 disposed along the Mth column are all red pixel units, the pixel units 470 disposed along the (M+1)th column are all green pixel units, and the pixel units 470 disposed along the (M+2)th column are all blue pixel units. However, the arrangement of the red, green, and blue pixel units is not limited to the embodiment shown in FIG. 4. In one embodiment, based on the arrangement of the pixel units disposed along the Nth row, the pixel units Pn+1_m, Pn+1_m+1, and Pn+1_m+2 along the (N+1)th row can be set as blue, red, and green pixel units respectively, and the arrangement of the other pixel units can be inferred accordingly. In another embodiment, based on the arrangement of the pixel units disposed along the Nth row, the pixel units Pn+1_m, Pn+1_m+1, and Pn+1_m+2 along the (N+1)th row can be set as green, blue, and red pixel units respectively, and the arrangement of the other pixel units can be inferred accordingly.

Each data switch 471 comprises a first end, a second end, and a gate. The first end of a data switch 471 is coupled to a corresponding liquid crystal capacitor 473 and a corresponding storage capacitor 475. The second end of a data switch 471 is coupled to a corresponding data line 460. The gate of a data switch 471 is coupled to a corresponding gate line 450. That is, the first end voltage of a data switch 471 is corresponding to a pixel voltage. Each liquid crystal capacitor 473 comprises a first end and a second end. The first end of a liquid crystal capacitor 473 is coupled to the first end of a corresponding data switch 471. The second end of a liquid crystal capacitor 473 is coupled to a corresponding liquid-crystal capacitor common line 480. Each storage capacitor 475 comprises a first end and a second end. The first end of a storage capacitor 475 is coupled to the first end of a corresponding data switch 471. The second end of a storage capacitor 475 is coupled to a corresponding storage capacitor common line 485.

The coupling relationships concerning related devices and related lines for the pixel units Pn_m, Pn_m+1, and Pn_m+2 in the Nth row are detailed as the followings. The gate of the data switch T1 is coupled to the gate line GLn. The first end of the data switch T1 is coupled to both the first ends of the liquid crystal capacitor CL1 and the storage capacitor CS1. The second end of the data switch T1 is coupled to the data line DLm+1. The second end of the liquid crystal capacitor CL1 is coupled to the liquid-crystal capacitor common line LLC_n. The second end of the storage capacitor CS1 is coupled to the storage capacitor common line LST_n. The first end voltage of the data switch T1 is the pixel voltage Vn_m of the pixel unit Pn_m.

The gate of the data switch T2 is coupled to the gate line GLn. The first end of the data switch T2 is coupled to both the first ends of the liquid crystal capacitor CL2 and the storage capacitor CS2. The second end of the data switch T2 is coupled to the data line DLm+2. The second end of the liquid crystal capacitor CL2 is coupled to the liquid-crystal capacitor common line LLC_n. The second end of the storage capacitor CS2 is coupled to the storage capacitor common line LST_n−1. The first end voltage of the data switch T2 is the pixel voltage Vn_m+1 of the pixel unit Pn_m+1.

The gate of the data switch T5 is coupled to the gate line GLn. The first end of the data switch T5 is coupled to both the first ends of the liquid crystal capacitor CL5 and the storage capacitor CS5. The second end of the data switch T5 is coupled to the data line DLm+3. The second end of the liquid crystal capacitor CL5 is coupled to the liquid-crystal capacitor common line LLC_n. The second end of the storage capacitor CS5 is coupled to the storage capacitor common line LST_n. The first end voltage of the data switch T5 is the pixel voltage Vn_m+2 of the pixel unit Pn_m+2.

The coupling relationships concerning related devices and related lines for the pixel units Pn+1_m, Pn+1_m+1, and Pn+1_m+2 in the (N+1)th row are detailed as the followings. The gate of the data switch T3 is coupled to the gate line GLn+1. The first end of the data switch T3 is coupled to both the first ends of the liquid crystal capacitor CL3 and the storage capacitor CS3. The second end of the data switch T3 is coupled to the data line DLm. The second end of the liquid crystal capacitor CL3 is coupled to the liquid-crystal capacitor common line LLC_n+1. The second end of the storage capacitor CS3 is coupled to the storage capacitor common line LST_n+1. The first end voltage of the data switch T3 is the pixel voltage Vn+1_m of the pixel unit Pn+1_m.

The gate of the data switch T4 is coupled to the gate line GLn+1. The first end of the data switch T4 is coupled to both the first ends of the liquid crystal capacitor CL4 and the storage capacitor CS4. The second end of the data switch T4 is coupled to the data line DLm+1. The second end of the liquid crystal capacitor CL4 is coupled to the liquid-crystal capacitor common line LLC_n+1. The second end of the storage capacitor CS4 is coupled to the storage capacitor common line LST_n. The first end voltage of the data switch T4 is the pixel voltage Vn+1_m+1 of the pixel unit Pn+1_m+1.

The gate of the data switch T6 is coupled to the gate line GLn+1. The first end of the data switch T6 is coupled to both the first ends of the liquid crystal capacitor CL6 and the storage capacitor CS6. The second end of the data switch T6 is coupled to the data line DLm+2. The second end of the liquid crystal capacitor CL6 is coupled to the liquid-crystal capacitor common line LLC_n+1. The second end of the storage capacitor CS6 is coupled to the storage capacitor common line LST_n+1. The first end voltage of the data switch T6 is the pixel voltage Vn+1_m+2 of the pixel unit Pn+1_m+2.

The coupling relationships concerning related devices and related lines for the pixel units Pn+2_m, Pn+2_m+1, and Pn+2_m+2 in the (N+2)th row are detailed as the followings. The gate of the data switch T7 is coupled to the gate line GLn+2. The first end of the data switch T7 is coupled to both the first ends of the liquid crystal capacitor CL7 and the storage capacitor CS7. The second end of the data switch T7 is coupled to the data line DLm+1. The second end of the liquid crystal capacitor CL7 is coupled to the liquid-crystal capacitor common line LLC_n+2. The second end of the storage capacitor CS7 is coupled to the storage capacitor common line LST_n+2. The first end voltage of the data switch T7 is the pixel voltage Vn+2_m of the pixel unit Pn+2_m.

The gate of the data switch T8 is coupled to the gate line GLn+2. The first end of the data switch T8 is coupled to both the first ends of the liquid crystal capacitor CL8 and the storage capacitor CS8. The second end of the data switch T8 is coupled to the data line DLm+2. The second end of the liquid crystal capacitor CL8 is coupled to the liquid-crystal capacitor common line LLC_n+2. The second end of the storage capacitor CS8 is coupled to the storage capacitor common line LST_n+1. The first end voltage of the data switch T8 is the pixel voltage Vn+2_m+1 of the pixel unit Pn+2_m+1.

The gate of the data switch T9 is coupled to the gate line GLn+2. The first end of the data switch T9 is coupled to both the first ends of the liquid crystal capacitor CL9 and the storage capacitor CS9. The second end of the data switch T9 is coupled to the data line DLm+3. The second end of the liquid crystal capacitor CL9 is coupled to the liquid-crystal capacitor common line LLC_n+2. The second end of the storage capacitor CS9 is coupled to the storage capacitor common line LST_n+2. The first end voltage of the data switch T9 is the pixel voltage Vn+2_m+2 of the pixel unit Pn+2_m+2. The coupling relationship between the plurality of storage capacitors 475 and the plurality of storage capacitor common lines 485 is not limited to the embodiment shown in FIG. 4. In another embodiment, the second ends of the storage capacitors CS1 and CS5 are coupled to the storage capacitor common line LST_n−1, the second ends of the storage capacitors CS2, CS3 and CS6 are coupled to the storage capacitor common line LST_n, the second ends of the storage capacitors CS4, CS7 and CS9 are coupled to the storage capacitor common line LST_n+1, and the second end of the storage capacitor CS8 is coupled to the storage capacitor common line LST_n+2.

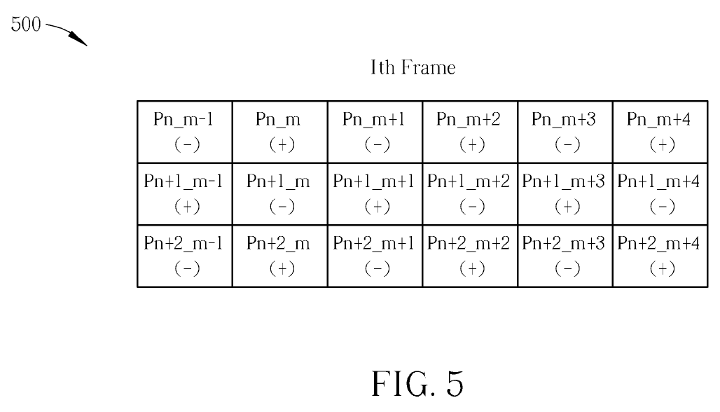

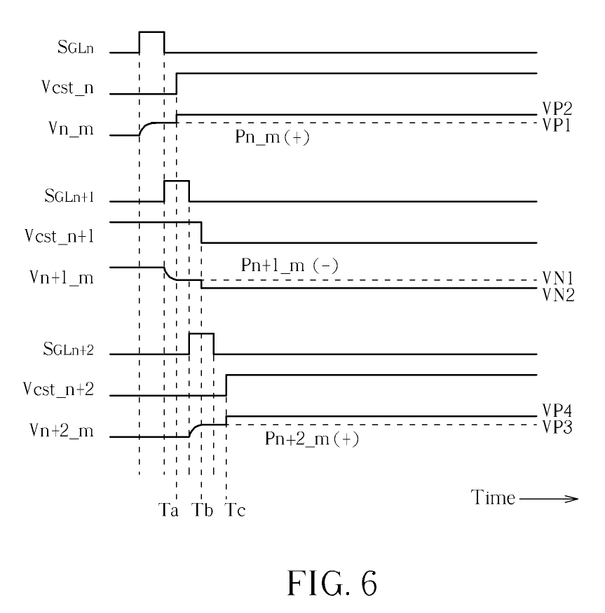

Please refer to FIGS. 5 and 6. FIG. 5 is a diagram schematically showing the pixel voltage polarities of the Ith frame 500 having dot-inversion feature generated based on the liquid crystal display device 400 shown in FIG. 4. FIG. 6 shows the related signal waveforms for generating the Ith frame 500 based on the liquid crystal display device 400 shown in FIG. 4, having time along the abscissa. The signal waveforms in FIG. 6, from top to bottom, are the gate signal SGLn, the storage capacitor common voltage Vcst_n, the pixel voltage Vn_m, the gate signal SGLn+1, the storage capacitor common voltage Vcst_n+1, the pixel voltage Vn+1_m, the gate signal SGLn+2, the storage capacitor common voltage Vcst_n+2, and the pixel voltage Vn+2_m. The following description details how the liquid crystal display device 400 operates by collocating the signal waveforms shown in FIG. 6 and the elements shown in FIG. 4.

When the gate signal SGLn is an enable signal having high voltage level, the data switch T1 is turned on and the data signal SDLm+1 with positive polarity is written into the liquid crystal capacitor CL1 and the storage capacitor CS1 via the data line DLm+1 and the data switch T1 so that the pixel voltage Vn_m is increased to the first positive-polarity gray-scale voltage VP1. When the gate signal SGLn is switched to a disable signal having low voltage level, the data switch T1 is turned off and subsequently the storage capacitor common voltage Vcst_n is switched from low voltage level to high voltage level at time Ta. As a result, the pixel voltage Vn_m will be boosted from the first positive-polarity gray-scale voltage VP1 to the second positive-polarity gray-scale voltage VP2 due to the capacitive effect caused by the storage capacitor CS1, which completes a writing process for furnishing the data signal with positive polarity to the pixel unit Pn_m.

When the gate signal SGLn+1 is an enable signal having high voltage level, the data switch T3 is turned on and the data signal SDLm with negative polarity is written into the liquid crystal capacitor CL3 and the storage capacitor CS3 via the data line DLm and the data switch T3 so that the pixel voltage Vn+1_m is decreased to the first negative-polarity gray-scale voltage VN1. When the gate signal SGLn+1 is switched to a disable signal having low voltage level, the data switch T3 is turned off and subsequently the storage capacitor common voltage Vcst_n+1 is switched from high voltage level to low voltage level at time Tb. As a result, the pixel voltage Vn+1_m will be shifted down from the first negative-polarity gray-scale voltage VN1 to the second negative-polarity gray-scale voltage VN2 due to the capacitive effect caused by the storage capacitor CS3, which completes a writing process for furnishing the data signal with negative polarity to the pixel unit Pn+1_m.

When the gate signal SGLn+2 is an enable signal having high voltage level, the data switch T7 is turned on and the data signal SDLm+1 with positive polarity is written into the liquid crystal capacitor CL7 and the storage capacitor CS7 via the data line DLm+1 and the data switch T7 so that the pixel voltage Vn+2_m is increased to the third positive-polarity gray-scale voltage VP3. When the gate signal SGLn+2 is switched to a disable signal having low voltage level, the data switch T7 is turned off and subsequently the storage capacitor common voltage Vcst_n+2 is switched from low voltage level to high voltage level at time Tc. As a result, the pixel voltage Vn+2_m will be boosted from the third positive-polarity gray-scale voltage VP3 to the fourth positive-polarity gray-scale voltage VP4 due to the capacitive effect caused by the storage capacitor CS7, which completes a writing process for furnishing the data signal with positive polarity to the pixel unit Pn+2_m.

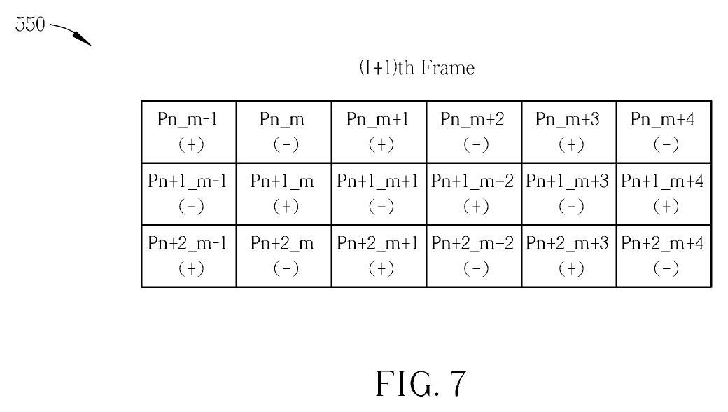

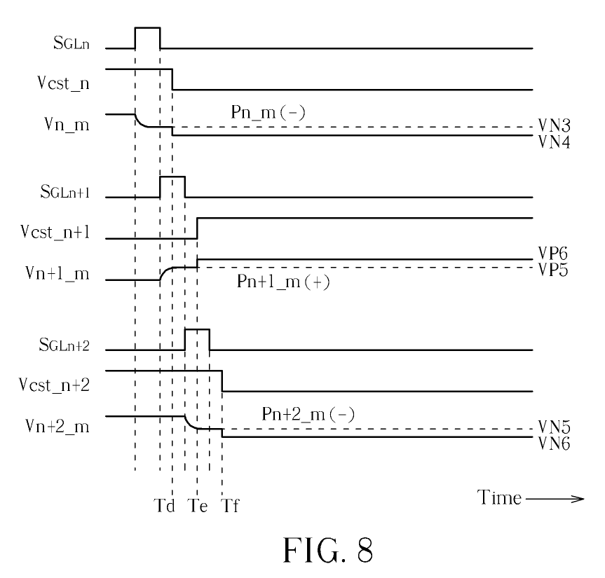

Please refer to FIGS. 7 and 8. FIG. 7 is a diagram schematically showing the pixel voltage polarities of the (I+1)th frame 550 having dot-inversion feature generated based on the liquid crystal display device 400 shown in FIG. 4. The (I+1)th frame 550 is a successive frame following the Ith frame 500 in FIG. 5. FIG. 8 shows the related signal waveforms for generating the (I+1)th frame 550 based on the liquid crystal display device 400 shown in FIG. 4, having time along the abscissa. The signal waveforms in FIG. 8, from top to bottom, are consecutive waveforms following the signal waveforms in FIG. 6. The following description details how the liquid crystal display device 400 operates by collocating the signal waveforms shown in FIG. 8 and the elements shown in FIG. 4.

When the gate signal SGLn is an enable signal having high voltage level, the data switch T1 is turned on and the data signal SDLm+1 with negative polarity is written into the liquid crystal capacitor CL1 and the storage capacitor CS1 via the data line DLm+1 and the data switch T1 so that the pixel voltage Vn_m is decreased to the third negative-polarity gray-scale voltage VN3. When the gate signal SGLn is switched to a disable signal having low voltage level, the data switch T1 is turned off and subsequently the storage capacitor common voltage Vcst_n is switched from high voltage level to low voltage level at time Td. As a result, the pixel voltage Vn_m will be shifted down from the third negative-polarity gray-scale voltage VN3 to the fourth negative-polarity gray-scale voltage VN4 due to the capacitive effect caused by the storage capacitor CS1, which completes a writing process for furnishing the data signal with negative polarity to the pixel unit Pn_m.

When the gate signal SGLn+1 is an enable signal having high voltage level, the data switch T3 is turned on and the data signal SDLm with positive polarity is written into the liquid crystal capacitor CL3 and the storage capacitor CS3 via the data line DLm and the data switch T3 so that the pixel voltage Vn+1 _m is increased to the fifth positive-polarity gray-scale voltage VP5. When the gate signal SGLn+1 is switched to a disable signal having low voltage level, the data switch T3 is turned off and subsequently the storage capacitor common voltage Vcst_n+1 is switched from low voltage level to high voltage level at time Te. As a result, the pixel voltage Vn+1_m will be boosted from the fifth positive-polarity gray-scale voltage VP5 to the sixth positive-polarity gray-scale voltage VP6 due to the capacitive effect caused by the storage capacitor CS3, which completes a writing process for furnishing the data signal with positive polarity to the pixel unit Pn+1_m.

When the gate signal SGLn+2 is an enable signal having high voltage level, the data switch T7 is turned on and the data signal SDLm+1 with negative polarity is written into the liquid crystal capacitor CL7 and the storage capacitor CS7 via the data line DLm+1 and the data switch T7 so that the pixel voltage Vn+2_m is decreased to the fifth negative-polarity gray-scale voltage VN5. When the gate signal SGLn+2 is switched to a disable signal having low voltage level, the data switch T7 is turned off and subsequently the storage capacitor common voltage Vcst_n+2 is switched from high voltage level to low voltage level at time Tf. As a result, the pixel voltage Vn+2_m will be shifted down from the fifth negative-polarity gray-scale voltage VN5 to the sixth negative-polarity gray-scale voltage VN6 due to the capacitive effect caused by the storage capacitor CS7, which completes a writing process for furnishing the data signal with negative polarity to the pixel unit Pn+2_m.

It is noted that the data signals outputted from the same data line 460 for displaying an image frame have the same polarity in the operation of the liquid crystal display device 400. That is, the data signals outputted from the same data line 460 switch polarities only when switching image frames. For that reason, the polarity switching frequency of the data signals outputted from the data lines 460 is significantly reduced while displaying image frames and the power consumption in the operation of the liquid crystal display device 400 is reduced accordingly.

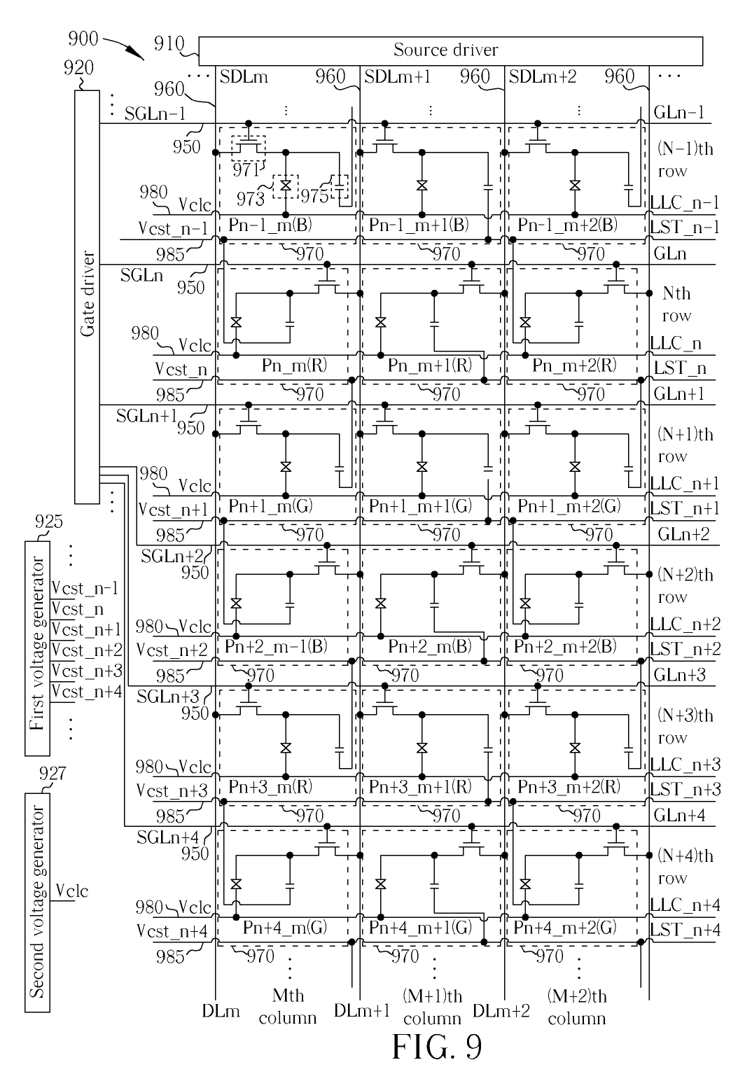

FIG. 9 is a structural diagram schematically showing a liquid crystal display device based on dot-inversion operation in accordance with a second embodiment of the present invention. As shown in FIG. 9, the liquid crystal display device 900 comprises a source driver 910, a gate driver 920, a first voltage generator 925, a second voltage generator 927, a plurality of parallel data lines 960, a plurality of parallel gate lines 950, a plurality of parallel liquid-crystal capacitor common lines 980, a plurality of storage capacitor common lines 985, and a plurality of pixel units 970. For the sake of brevity, FIG. 9 demonstrates only three data lines DL_m-DL_m+2, six liquid-crystal capacitor common lines LLC_n−1-LLC_n+4, six gate lines GL_n−1-GL_n+4, six storage capacitor common lines LST_n−1-LST_n+4, and several pixel units Pn−1_m-Pn+4_m+2.

The source driver 910 is utilized to provide a plurality of data signals. The gate driver 920 is utilized to provide a plurality of gate signals. The first voltage generator 925 is utilized to provide a plurality of storage capacitor common voltages. The second voltage generator 927 is utilized to provide a liquid-crystal capacitor common voltage Vclc. Each data line 960 is coupled to the source driver 910 for receiving a corresponding data signal. The pluralities of gate lines 950, liquid-crystal capacitor common lines 980, and storage capacitor common lines 985 are crossed with the plurality of data lines 960 perpendicularly. Each gate line 950 is coupled to the gate driver 920 for receiving a corresponding gate signal.

Each liquid-crystal capacitor common line 980 is coupled to the second voltage generator 927 for receiving the liquid-crystal capacitor common voltage Vclc. Each storage capacitor common line 985 is coupled to the first voltage generator 925 for receiving a corresponding storage capacitor common voltage. Each pixel unit 970 comprises a corresponding data switch 971, a corresponding liquid crystal capacitor 973, and a corresponding storage capacitor 975.

Based on the R, G, and B labeled in parentheses at each pixel unit 970 shown in FIG. 9, it is obvious that the pixel units 970 disposed in the same row have same pixel color in the liquid crystal display device 900. For instance, the pixel units 970 disposed along the Nth row are all red pixel units, the pixel units 970 disposed along the (N+1)th row are all green pixel units, and the pixel units 970 disposed along the (N+2)th row are all blue pixel units. However, the arrangement of the red, green, and blue pixel units is not limited to the embodiment shown in FIG. 9. In one embodiment, based on the arrangement of the pixel units disposed along the Mth column, the pixel units Pn_m+1, Pn+1_m+1, and Pn+2_m+1 along the (M+1)th column can be set as blue, red, and green pixel units respectively, and the arrangement of the other pixel units can be inferred accordingly. In another embodiment, based on the arrangement of the pixel units disposed along the Mth column, the pixel units Pn_m+1, Pn+1_m+1, and Pn+2_m+1 along the (M+1)th column can be set as green, blue, and red pixel units respectively, and the arrangement of the other pixel units can be inferred accordingly.

The coupling relationships concerning the data switch 971, the liquid crystal capacitor 973, and the storage capacitor 975 of each pixel unit 970 of the liquid crystal display device 900 are similar to the aforementioned coupling relationships for the liquid crystal display device 400. Furthermore, the related waveforms for generating image frames having dot-inversion feature based on the liquid crystal display device 900 are identical to the aforementioned waveforms concerning the operations of the liquid crystal display device 400 shown in FIGS. 6 and 8, and for the sake of brevity, further similar discussion is omitted.

Compared with the liquid crystal display device 400, the red, green, and blue pixel units are disposed periodically along column direction in the liquid crystal display device 900 instead of along row direction. Consequently, the number of gate lines required in the liquid crystal display device 900 is much greater than the number of gate lines required in the liquid crystal display device 400. However, the number of data lines required in the liquid crystal display device 900 is far less than the number of data lines required in the liquid crystal display device 400. In general, the gate driver is embedded in the display panel of the liquid crystal display device, and hence the increased number of gate lines have little effect on manufacture complexity and production cost. On the other hand, the source driver is not embedded in the display panel of the liquid crystal display device, and each data channel of the source driver is disposed with one corresponding digital-to-analog converter. Therefore, the reduced number of data lines leads to the advantage of lower circuit complexity for devising the source driver. Moreover, the complexity of the coupling interface between the source driver and the display panel is also lowered accordingly.

In summary, the liquid crystal display device of the present invention makes use of AC storage capacitor common voltage for reducing voltage swing between positive-polarity and negative-polarity gray-scale voltages so that the power consumption concerning polarity switching can be reduced. Furthermore, since the voltage tolerance required for the components is lowered, the components having lower rating voltage can be installed in the source driver for lowering production cost. Moreover, by reason of same-polarity data signals outputted from same data line while displaying an image frame, the polarity switching frequency in the operation of the liquid crystal display device is lowered significantly. That is, the power consumption in the operation of the liquid crystal display device of the present invention can be further reduced based on the lower polarity switching frequency.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A liquid crystal display device based on dot-inversion operation comprising:
a plurality of parallel data lines, each of the plurality of data lines receiving a corresponding data signal;
a plurality of parallel gate lines crossed with the plurality of data lines perpendicularly, each of the plurality of gate lines receiving a corresponding gate signal;
a plurality of parallel storage capacitor common lines crossed with the plurality of data lines perpendicularly, each of the plurality of storage capacitor common lines receiving a corresponding storage capacitor common voltage;
an Nth row of pixel units comprising:
an Mth pixel unit comprising:
a first data switch comprising a first end, a second end coupled to an (M+1)th data line of the plurality of data lines, and a gate coupled to an Nth gate line of the plurality of gate lines; and
a first storage capacitor comprising a first end coupled to the first end of the first data switch; and
an (M+1)th pixel unit comprising:
a second data switch comprising a first end, a second end coupled to an (M+2)th data line of the plurality of data lines, and a gate coupled to the Nth gate line; and
a second storage capacitor comprising a first end coupled to the first end of the second data switch; and
an (N+1)th row of pixel units comprising:
an Mth pixel unit comprising:
a third data switch comprising a first end, a second end coupled to an Mth data line of the plurality of data lines, and a gate coupled to an (N+1)th gate line of the plurality of gate lines; and
a third storage capacitor comprising a first end coupled to the first end of the third data switch; and
an (M+1)th pixel unit comprising:
a fourth data switch comprising a first end, a second end coupled to the (M+1)th data line, and a gate coupled to the (N+1)th gate line; and
a fourth storage capacitor comprising a first end coupled to the first end of the fourth data switch.

2. The liquid crystal display device of claim 1, further comprising:
a voltage generator coupled to the plurality of storage capacitor common lines for providing the plurality of storage capacitor common voltages.

3. The liquid crystal display device of claim 1, further comprising:
a source driver coupled to the plurality of data lines for providing the plurality of data signals; and
a gate driver coupled to the plurality of gate lines for providing the plurality of gate signals.

4. The liquid crystal display device of claim 1, wherein the first data switch, the second data switch, the third data switch, and the fourth data switch are thin film transistors.

5. The liquid crystal display device of claim 1, wherein the first data switch, the second data switch, the third data switch, and the fourth data switch are MOS field effect transistors.

6. The liquid crystal display device of claim 1, wherein:
the first storage capacitor further comprises a second end coupled to an (N−1)th storage capacitor common line of the plurality of storage capacitor common lines;
the second storage capacitor further comprises a second end coupled to an Nth storage capacitor common line of the plurality of storage capacitor common lines;
the third storage capacitor further comprises a second end coupled to the Nth storage capacitor common line; and
the fourth storage capacitor further comprises a second end coupled to an (N+1)th storage capacitor common line of the plurality of storage capacitor common lines.

7. The liquid crystal display device of claim 6, further comprising:
a plurality of parallel liquid-crystal capacitor common lines crossed with the plurality of data lines perpendicularly, each of the plurality of liquid-crystal capacitor common lines receiving a liquid-crystal capacitor common voltage.

8. The liquid crystal display device of claim 7, further comprising:
a voltage generator coupled to the plurality of liquid-crystal capacitor common lines for providing the liquid-crystal capacitor common voltage to the plurality of liquid-crystal capacitor common lines.

9. The liquid crystal display device of claim 7, wherein:
the Mth pixel unit of the Nth row of pixel units further comprises:
a first liquid-crystal capacitor comprising a first end coupled to the first end of the first data switch, and a second end coupled to an Nth liquid-crystal capacitor common line of the plurality of liquid-crystal capacitor common lines;
the (M+1)th pixel unit of the Nth row of pixel units further comprises:
a second liquid-crystal capacitor comprising a first end coupled to the first end of the second data switch, and a second end coupled to the Nth liquid-crystal capacitor common line;
the Mth pixel unit of the (N+1)th row of pixel units further comprises:
a third liquid-crystal capacitor comprising a first end coupled to the first end of the third data switch, and a second end coupled to an (N+1)th liquid-crystal capacitor common line of the plurality of liquid-crystal capacitor common lines; and
the (M+1)th pixel unit of the (N+1)th row of pixel units further comprises:
a fourth liquid-crystal capacitor comprising a first end coupled to the first end of the fourth data switch, and a second end coupled to the (N+1)th liquid-crystal capacitor common line.

10. The liquid crystal display device of claim 9, further comprising:
a voltage generator coupled to the plurality of storage capacitor common lines and the plurality of liquid-crystal capacitor common lines for providing the plurality of storage capacitor common voltages and the liquid-crystal capacitor common voltage.

11. The liquid crystal display device of claim 9, wherein:
the Nth row of pixel units further comprises:
an (M+2)th pixel unit comprising:
a fifth data switch comprising a first end, a second end coupled to an (M+3)th data line of the plurality of data lines, and a gate coupled to the Nth gate line; and
a fifth storage capacitor comprising a first end coupled to the first end of the fifth data switch, and a second end coupled to the (N−1)th storage capacitor common line; and
the (N+1)th row of pixel units further comprises:
an (M+2)th pixel unit comprising:
a sixth data switch comprising a first end, a second end coupled to the (M+2)th data line, and a gate coupled to the (N+1)th gate line; and
a sixth storage capacitor comprising a first end coupled to the first end of the sixth data switch, and a second end coupled to the Nth storage capacitor common line.

12. The liquid crystal display device of claim 11, wherein the Mth pixel unit of the Nth row of pixel units is a red pixel unit, the (M+1)th pixel unit of the Nth row of pixel units is a green pixel unit, and the (M+2)th pixel unit of the Nth row of pixel units is a blue pixel unit.

13. The liquid crystal display device of claim 12, wherein the Mth pixel unit of the (N+1)th row of pixel units is a red pixel unit, the (M+1)th pixel unit of the (N+1)th row of pixel units is a green pixel unit, and the (M+2)th pixel unit of the (N+1)th row of pixel units is a blue pixel unit.

14. The liquid crystal display device of claim 12, wherein the Mth pixel unit of the (N+1)th row of pixel units is a blue pixel unit, the (M+1)th pixel unit of the (N+1)th row of pixel units is a red pixel unit, and the (M+2)th pixel unit of the (N+1)th row of pixel units is a green pixel unit.

15. The liquid crystal display device of claim 11, wherein:
the (M+2)th pixel unit of the Nth row of pixel units further comprises:
a fifth liquid-crystal capacitor comprising a first end coupled to the first end of the fifth data switch, and a second end coupled to the Nth liquid-crystal capacitor common line; and
the (M+2)th pixel unit of the (N+1)th row of pixel units further comprises:
a sixth liquid-crystal capacitor comprising a first end coupled to the first end of the sixth data switch, and a second end coupled to the (N+1)th liquid-crystal capacitor common line.

16. The liquid crystal display device of claim 9, further comprising:
an (N+2)th row of pixel units comprising:
an Mth pixel unit comprising:
a seventh data switch comprising a first end, a second end coupled to the (M+1)th data line, and a gate coupled to an (N+2)Nth gate line of the plurality of gate lines; and
a seventh storage capacitor comprising a first end coupled to the first end of the seventh data switch, and a second end coupled to the (N+1)th storage capacitor common line; and
an (M+1)th pixel unit comprising:
an eighth data switch comprising a first end, a second end coupled to the (M+2)th data line, and a gate coupled to the (N+2)th gate line; and
an eighth storage capacitor comprising a first end coupled to the first end of the eighth data switch, and a second end coupled to an (N+2)th storage capacitor common line of the plurality of storage capacitor common lines.

17. The liquid crystal display device of claim 16, wherein the Mth pixel unit of the Nth row of pixel units is a red pixel unit, the Mth pixel unit of the (N+1)th row of pixel units is a green pixel unit, and the Mth pixel unit of the (N+2)th row of pixel units is a blue pixel unit.

18. The liquid crystal display device of claim 1 7, wherein the (M+1)th pixel unit of the Nth row of pixel units is a red pixel unit, the (M+1)th pixel unit of the (N+1)th row of pixel units is a green pixel unit, and the (M+1)th pixel unit of the (N+2)th row of pixel units is a blue pixel unit.

19. The liquid crystal display device of claim 17, wherein the (M+1)th pixel unit of the Nth row of pixel units is a green pixel unit, the (M+1)th pixel unit of the (N+1)th row of pixel units is a blue pixel unit, and the (M+1)th pixel unit of the (N+2)th row of pixel units is a red pixel unit.

20. The liquid crystal display device of claim 16, wherein:
the Mth pixel unit of the (N+2)th row of pixel units further comprises:
a seventh liquid-crystal capacitor comprising a first end coupled to the first end of the seventh data switch, and a second end coupled to an (N+2)th liquid-crystal capacitor common line of the plurality of liquid-crystal capacitor common lines; and
the (M+1)th pixel unit of the (N+2)th row of pixel units further comprises:
an eighth liquid-crystal capacitor comprising a first end coupled to the first end of the eighth data switch, and a second end coupled to the (N+2)th liquid-crystal capacitor common line.
